(19) United States
(12) Patent Application Publication
(10) Pub. No.: US 2009/0082503 A1
(43) Pub. Date: Mar. 26, 2009

(54) INKJET INK, METHOD OF PRODUCING THE SAME, AND INK SET

(75) Inventors: Terukazu YANAGI, Ashigarakami-gun (JP); Takahiro ISHIZUKA, Ashigarakami-gun (JP); Akio TAMURA, Ashigarakami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/208,073

(22) Filed: Sep. 10, 2008

(30) Foreign Application Priority Data
Sep. 26, 2007 (JP) 2007-250018

(51) Int. Cl. C09D 11/02; C08K 5/09; C08K 3/22

(52) U.S. Cl. 524/301; 524/413; 524/80

(57) ABSTRACT

The invention provides a method of producing an inkjet ink, the method including at least subjecting a polymer particle dispersion liquid to centrifuge processing, and mixing the polymer particle dispersion liquid that has been subjected to the centrifuge processing and a water-insoluble coloring particle dispersion liquid, as well as an ink set including the produced inkjet ink and a processing liquid that causes the ink to aggregate.

### CROSS-REFERENCE TO RELATED APPLICATION

This application claims priority under 35 USC 119 from Japanese Patent Application No. 2007-250018, the disclosure of which is incorporated by reference herein.

### BACKGROUND OF THE INVENTION

1. Field of the Invention

The present invention relates to an inkjet ink, a method of producing the same, and an ink set including the inkjet ink.

2. Description of the Related Art

An inkjet recording method is a method for carrying out recording by ejecting ink droplets from each of a plurality of nozzles formed at an inkjet head, and in view of the fact that noise at the time of a recording operation is low, running costs are inexpensive, and high-quality images can be recorded on a wide variety of recording mediums, the inkjet recording method is widely utilized.

As an inkjet ink that is used in an inkjet recording method, an inkjet ink that contains polymer particles for the purposes of improving the fixability, abrasion resistance, scratch resistance, glossiness, water resistance and the like of an inkjet recorded image is known (for example, refer to Japanese Patent Application Laid-Open (JP-A) No. 2006-188601).

Further, an inkjet ink that contains polymer particles comprising a water-insoluble colorant in a hardly water-soluble polymer for the purpose of improving dischargeability of the inkjet ink is known (for example, refer to JP-A No. 2003-138176).

Furthermore, a two-liquid reaction method for promoting fixing of ink by causing two liquids, including an ink and a processing liquid that causes the ink to aggregate, to react with each other to cause the ink to aggregate is known (for example, refer to JP-A No. 2003-82265).

### SUMMARY OF THE INVENTION

The present invention has been made in view of the above circumstances and provides an inkjet ink, a method of producing the same, and an ink set.

According to a first aspect of the invention, there is provided a method of producing an inkjet ink, the method comprising at least subjecting a polymer particle dispersion liquid to centrifuge processing, and mixing the polymer particle dispersion liquid that has been subjected to the centrifuge processing and a water-insoluble coloring particle dispersion liquid.

According to a second aspect of the present invention, there is provided an inkjet ink produced by the method of producing an inkjet ink according to the first aspect.

According to a third aspect of the present invention, there is provided an ink set comprising the inkjet ink according to the second aspect and a processing liquid that causes the ink to aggregate.

### DETAILED DESCRIPTION OF THE INVENTION

In the inkjet ink disclosed in JP-A No. 2006-188601, it can hardly be said that the filterability of the ink and the dischargeability of the ink are sufficient. Further, in the inkjet ink disclosed in JP-A No. 2003-138176, it can hardly be said that the fixability, abrasion resistance, scratch resistance, glossiness, water resistance and the like of a recorded image are sufficient. Furthermore, in the inkjet recording method disclosed in JP-A No. 2003-82265, it can hardly be said that the aggregation reaction speed of the ink is sufficient.

The present invention has been made in view of the above circumstances.

Hereinafter, an inkjet ink, a method of producing the same, and an ink set of the present invention will be explained.

### <Method of Producing Inkjet Ink>

The method of producing an inkjet ink of the present invention comprises at least subjecting a polymer particle dispersion liquid to centrifuge processing, and mixing the polymer particle dispersion liquid that has been subjected to the centrifuge processing and a water-insoluble coloring particle dispersion liquid. By producing the inkjet ink using the polymer particle dispersion liquid that has been subjected to the centrifuge processing, the filterability and the dischargeability of the inkjet ink can be improved. Further, by configuring the inkjet ink to comprise the polymer particle dispersion liquid and the water-insoluble coloring particle dispersion liquid, the fixability, abrasion resistance, scratch resistance, glossiness and water resistance of a recorded image formed by the inkjet ink can be effectively improved.

### (Polymer Particle Dispersion Liquid)

The polymer used in the polymer particles in the present invention will be explained.

Examples of the polymer in the present invention include homopolymers such as polyolefin, polystyrene, polyvinyl, polyacryl, polyhalo-olefin, polydiene, polyether, polysulfide, polyethylene, polyamide, polyurethane, polyurea, polyimide, poly acid anhydride, polycarbonate, polyimine, polysiloxane, polyphosphazene, polyketone, polysulfone, polyphenylene and the like, and copolymers of these.

Preferable examples include homopolymers such as polyolefin, polystyrene, polyvinyl, polyacryl, polyhalo-olefin, polydiene, polyether, polyethylene, polyamide, polyurethane, polyurea, polyimide, polycarbonate and polyimine, and copolymers thereof, more preferable examples are homopolymers such as polyolefin, polystyrene, polyacryl, polyhalo-olefin, polydiene, polyether and polyethylene, and copolymers thereof, particularly preferable examples are homopolymers such as polystyrene and polyacryl, and copolymers thereof, and a styrene-acryl copolymer is particularly preferable. Furthermore, in this styrene-acryl copolymer, it is preferable that styrene is contained in an amount of 50 mass % or more.

Specific examples of a styrene monomer derivative constituting the polystyrene or styrene-acryl copolymer include styrene, 2-methylstyrene, vinyl toluene, t-butylstyrene, chlorstyrene, vinylanisole, vinylnaphthalene and the like.

Further, examples of an acryl-based monomer used in the polyacryl or styrene-acryl copolymer include acrylic acid, acrylic acid ester and acrylic acid amide, as well as methacrylic acid, methacrylic acid ester and methacrylic acid amide.

Specific examples of the acrylic acid ester include methyl acrylate, ethyl acrylate, isopropyl acrylate, n-butyl acrylate, isobutyl acrylate, n-amyl acrylate, isoamyl acrylate, n-hexyl acrylate, 2-ethylhexyl acrylate, octyl acrylate, decyl acrylate, dodecyl acrylate, octadecyl acrylate, cyclohexyl acrylate, phenyl acrylate, benzyl acrylate, glycidyl acrylate and the like.

Further, specific examples of the acrylic acid amide include acrylamide, N,N-dimethyl aminopropyl acrylamide, N,N-dimethyl acrylamide, acryloyl morpholine, N-isopropyl acrylamide, N,N-diethyl acrylamide and the like.

Specific examples of the methacrylic acid ester include methyl methacrylate, ethyl methacrylate, isopropyl methacrylate, n-butyl methacrylate, isobutyl methacrylate, n-amyl methacrylate, isoamyl methacrylate, n-hexyl methacrylate, 2-ethylhexyl methacrylate, octyl methacrylate, decyl methacrylate, dodecyl methacrylate, octadecyl methacrylate, cyclohexyl methacrylate, phenyl methacrylate, benzyl methacrylate, glycidyl methacrylate and the like.

Further, in the styrene-acryl copolymer, in addition to the styrene monomer derivative and the acryl-based monomer, a component that is capable of being copolymerized with these may be further included. Examples of the copolymerizable component include vinyl esters (for example, vinyl acetate or the like), vinyl cyan compounds (for example, acrylonitrile, methacrylonitrile or the like), halogenated monomers (for example, vinylidene chloride, vinyl chloride or the like), olefins (for example, ethylene, propylene, isopropylene or the like), dienes (for example, butadiene, isoprene, chloroprene or the like), vinyl monomers (for example, vinyl ether, vinyl ketone, vinyl pyrrolidone or the like) and the like. A plurality of these monomers may be combined.

Further, the polymer in the present invention may further contain, as the copolymerizable component, an anionic monomer or a cationic monomer as a monomer that improves a dispersion stabilization effect of the polymer particles.

The anionic monomer refers to a monomer compound containing an anionic group that can hold a negative electrical charge. The anionic group may be any group, as long as it is a group having a negative electrical charge. In the present invention, it is preferable that the anionic group is a phosphoric acid group, a phosphonic acid group, a phosphinic acid group, a sulfuric acid group, a sulfonic acid group, a sulfinic acid group or a carboxy group, it is more preferable that the anionic group is a phosphoric acid group or a carboxy group, and it is even more preferable that the anionic group is a carboxy group.

Examples of the monomer containing the carboxy group include acrylic acid, methacrylic acid, itaconic acid, fumaric acid, maleic acid and the like. Acrylic acid and methacrylic acid are preferable.

The cationic monomer refers to a monomer containing an cationic group that can hold a positive electrical charge. The cationic group may be any group, as long as it is a group having a positive electrical charge. In the present invention, it is preferable that the cationic group is an organic cationic substituent, it is more preferable that the cationic group is an organic cationic group containing a nitrogen atom or a phosphorus atom, and it is even more preferable that the cationic group is a pyridinium cation or an ammonium cation.

Examples of the cationic monomer include monomers containing a pyridinium cation or an ammonium cation, or the like. A monomer containing an ammonium cation is preferable, and more preferable examples include N,N-dimethyl aminoethyl acrylate, N,N-dimethyl aminoethyl methacrylate, vinylimidazole and the like.

Concrete examples LX-1 through LX-10 of a primary structure of a polymer (latex compound LX) that is preferable as the polymer particles in the present invention are shown below. It should be noted that a, b, c and d in the concrete examples represent mass ratio of the respective repeating units.

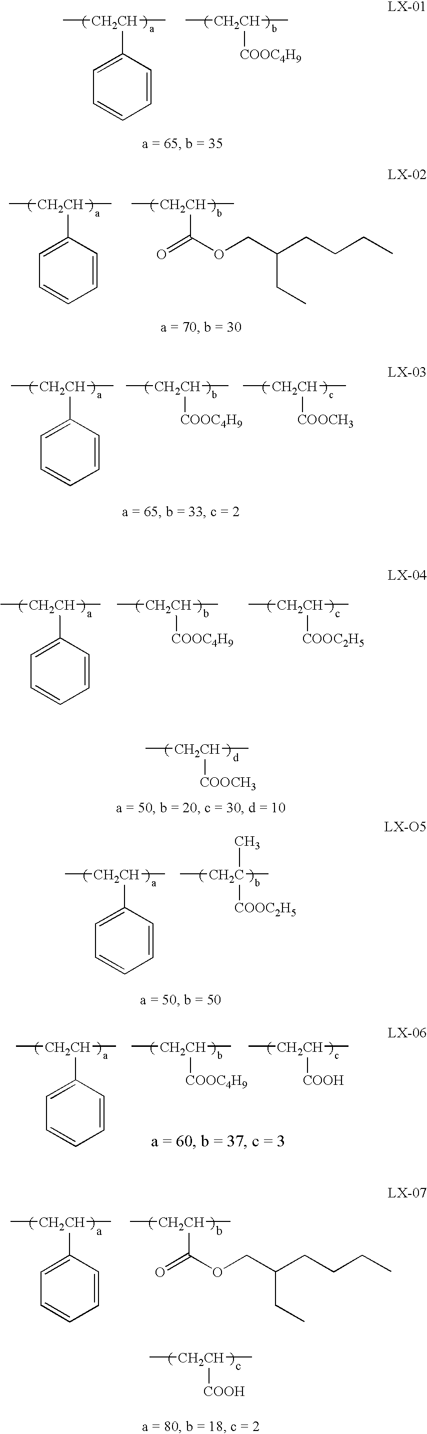

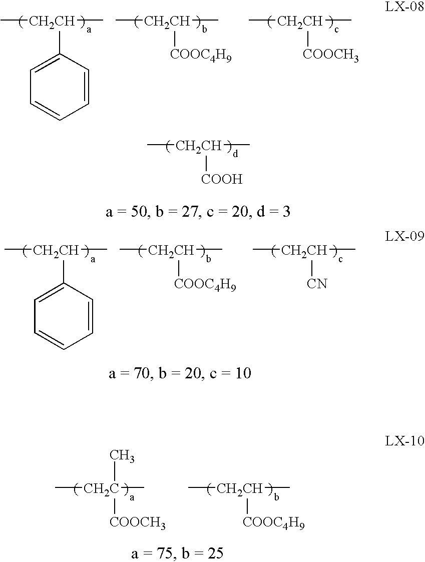

Further, a weight-average molecular weight of the polymer used in the polymer particles is within a range of from 1,000 to 1,000,000, more preferably within a range of from 5,000 to 500,000, even more preferably within a range of from 10,000 to 500,000, and particularly preferably within a range of from 20,000 to 500,000.

The polymers of the above-described concrete examples can be preferably used as the polymer of the polymer particles in the present invention. In particular, it is particularly preferable that the weight-average molecular weight thereof is from 100,000 to 500,000, that at least a styrene monomer and an acrylic acid ester monomer are comprised therein, and that a percentage of the styrene monomer is from 50 to 99 mass %.

The polymer can be synthesized by various polymerization methods without any particular limitation. For example, this can be carried out by solution polymerization, precipitation polymerization, suspension polymerization, bulk polymerization or emulsion polymerization. Further, synthesis may be carried out by a well known operation, such as those of a batch-wise system, a semi-continuous system, a continuous system or the like.

Further, the polymer particle dispersion liquid in the present invention is one in which polymer particles comprising the above-described polymer are emulsion-dispersed in an aqueous medium. The polymer particle dispersion liquid can be produced using a well known method without any particular limitation. For example, an emulsion polymerization method, an emulsion dispersion method or the like can be used, and specifically, production can be carried out by methods disclosed in JP-A No. 62-241901 and JP-A No. 3-79678, or the like.

### —Emulsion Polymerization Method—

Emulsion polymerization can be carried out, for example, by polymerizing an emulsion produced by adding a monomer, a polymerization initiator, an emulsifier (which may also include polymer emulsifiers; hereinafter, simply referred to as an emulsifier in some cases) and, in accordance with necessity, a water-soluble polymerization chain transfer agent or the like, to an aqueous medium (for example, water or the like).

The monomer is not particularly limited, and monomers that can be used as a component of the aforementioned polymer can be preferably used.

Further, the polymerization initiator is not particularly limited, and inorganic persulfates (for example, potassium persulfate, sodium persulfate, ammonium persulfate or the like), azo-based initiators (for example, 2,2′-azobis(2-amidinopropane)dihydrochloride, 2,2′-azobis[2-methyl-N-(2-hydroxyethyl)-propionamide] or the like), organic peroxides (for example, t-butyl peroxypivalate, t-butyl hydroperoxide or the like), or the like can be used. These can be used singly or in a combination of two or more.

Among these, it is preferable that an azo-based initiator or an organic peroxide is used, from the standpoint of aggregability of the polymer particles.

An amount of the polymerization initiator to be used in the present invention is normally 0.01 to 2 mass %, and preferably 0.2 to 1 mass %, with respect to a total amount of monomers.

As the emulsifier in the present invention, well known emulsifiers can be used without any particular limitation. Examples thereof include anionic, cationic, amphoteric and nonionic surfactants, as well as water-soluble polymers and the like. Specific examples include sodium laurate, sodium dodecylsulfate, sodium 1-octoxy carbonyl methyl-1-octoxy carbonyl methane sulfonate, sodium lauryl naphthalene sulfonate, sodium lauryl benzene sulfonate, sodium lauryl phosphate, cetyltrimethylammonium chloride, dodecyl trimethylene ammonium chloride, N-2-ethylhexyl pyridinium chloride, polyoxyethylene nonylphenyl ether, polyoxyethylene sorbitan lauryl ester, sodium dodecyl diphenylether disulfonate, sodium 2-tetradecene-1-sulfonate, sodium 3-hydroxy tetradecane-1-sulfonate, aliphatic acid alkali metal salt, succinic acid alkali metal salt, alkenyl succinic acid metal salt, gelatin, PVA, other emulsifiers and water-soluble polymers disclosed in Japanese Patent Application Publication (JP-B) No. 53-6190, and the like.

An amount of the emulsifier to be used in the present invention is preferably 1 to 50 mass %, and more preferably 2 to 20 mass %, with respect to a total amount of monomers, from the standpoint of aggregability of the polymer particles.

Further, as the chain transfer agent, well known compounds such as carbon tetrahalide, dimers of styrene, dimers of (meth)acrylic acid ester, mercaptans, sulfides and the like can be used. Among these, dimers of styrene and mercaptans disclosed in JP-A No. 5-17510 can be preferably used.

### —Emulsion Dispersion—

As the emulsion dispersion in the present invention, well known emulsion dispersion methods can be used without any particular limitation. For example, either of methods including a forced emulsion method in which a polymer solution or a melt polymer is emulsion-dispersed in an aqueous medium containing an emulsifier, or a phase inversion emulsion method in which an emulsifier is dissolved in a polymer solution and an aqueous medium is added thereto, or an aqueous medium solution of an emulsifier is gradually added to a polymer solution, to carry out phase inversion, may be used.

As the polymer solution or the melt polymer, the above-described polymer can be used. Further, the emulsifier is as described above.

It is preferable to obtain the polymer particle dispersion liquid in the present invention in the form of an aqueous dispersion (latex) by the aforementioned emulsion polymerization method, from the standpoints of dispersability and fixability.

Further, as the polymer particle dispersion liquid in the present invention, commercially available polymer particle dispersion liquids (latex) can be used. Examples of the commercially available latex include, for example, JONCRYL (manufactured by BASF Japan Ltd.), JURYMER (manufactured by Nihon Junyaku Co., Ltd.), ZAIKTHENE-L (manufactured by Sumitomo Seika Chemicals Co., Ltd.), CHEMIPEARL S-120 (manufactured by Mitsui Chemicals, Inc.) and the like.

The average particle diameter of the polymer particles in the polymer particle dispersion liquid is preferably from 20 nm to 400 nm, and more preferably from 20 nm to 200 nm. Due to the average particle diameter being 20 nm or greater, aggregation properties are improved. Further, due to the average particle diameter being 400 nm or less, ink ejectability is improved.

Further, the particle size distribution of the polymer particles is not particularly limited and may be either of one having a wide particle size distribution or one having a particle size distribution of a monodispersion. Furthermore, two or more polymers having a particle size distribution of a monodispersion may be mixed and used.

It should be noted that the average particle diameter of the polymer particles can be measured, for example, according to an ordinary light scattering method.

### (Centrifuge Processing)

In the present invention, centrifuge processing is carried out with respect to the polymer particle dispersion liquid. Due to producing the inkjet ink by using the polymer particle dispersion liquid which has been subjected to the centrifuge processing, filterability and dischargeability of the inkjet ink can be improved.

In the present invention, it is preferable that a process of recovering a supernatant of the polymer particle dispersion liquid is provided after the centrifuge processing. Further, it is preferable that a filtration process is provided in the process of recovering the supernatant. In the filtration step, mesh corresponding to the particle diameter of the polymer particles can be used. By providing the step of recovering the supernatant after the centrifuge processing, filterability and dischargeability of the inkjet ink can be improved more effectively.

Regarding a centrifuge apparatus that carries out the centrifuge processing, commercially available centrifuge apparatuses can be preferably used. Among these, a high-speed cooled centrifuge is preferable from the standpoints of filterability and dischargeability of the inkjet ink.

As for conditions of the centrifuge processing in the present invention, a centrifugal acceleration is preferably 640 to 64,000×g, more preferably 4,000 to 30,000×g, and even more preferably 10,000 to 30,000×g. The centrifugal acceleration in the centrifuge processing can be calculated from the centrifuge rotation speed and the centrifuge radius.

Further, it is preferable that a processing time is shorter, the larger the centrifugal acceleration is, and that the processing time is longer, the smaller the centrifugal acceleration is. As the processing time, from 15 minutes to 3 hours is preferable, from 30 minutes to 2 hours is more preferable, and from 1 hour to 1.5 hours is even more preferable.

Furthermore, in a case where the polymer particles have a glass transition temperature (Tg), it is preferable that a temperature at the time of the centrifuge processing is set at a temperature that is equal to or less than the Tg. Generally, 5 to 60° C. is preferable, 5 to 45° C. is more preferable, and 10 to 45° C. is even more preferable.

It is preferable that the conditions of the centrifuge processing in the present invention are set at 640 to 64,000×g for from 15 minutes to 3 hours, it is more preferable that they are set at 4,000 to 30,000×g for from 30 minutes to 2 hours, and it is even more preferable that they are set at 10,000 to 30,000×g for from 1 hour to 1.5 hours.

In the present invention, it is preferable that a process of further mixing a surfactant in the polymer particle dispersion liquid is further provided. As a result, filterability and dischargeability of the inkjet ink can be improved more effectively.

The mixing of the polymer particle dispersion liquid and the surfactant may be carried out before the centrifuge processing, or may be carried out before the filtration process after the centrifuge processing. In the present invention, it is preferable that this is carried out before the centrifuge processing from the standpoints of filterability and dischargeability of the inkjet ink.

Further, in the present invention, it is preferable that a process of adjusting pH of a mixed liquid of the polymer particle dispersion liquid and the surfactant to from 7 to 10 is further provided. As a result, filterability and dischargeability of the inkjet ink is more effectively improved.

The adjustment of the pH of the mixed liquid can be carried out by adding and mixing an acidic compound or an alkaline compound according to an ordinary method. As the acidic compound or alkaline compound, well known acidic compounds and alkaline compounds can be used without any particular limitation. Specific examples of the acidic compound include hydrochloric acid, sulfuric acid, phosphoric acid and the like, and specific examples of the alkaline compound include lithium hydroxide, potassium hydroxide, sodium hydroxide, ammonia, triethylamine and the like.

In the present invention, the pH of the mixed liquid of the polymer particle dispersion liquid and the surfactant is preferably from 7 to 10, and more preferably from 8 to 10.

The process of adjusting the pH of the mixed liquid may be carried out before the centrifuge processing, or may be carried out before the filtration process after the centrifuge processing. In the present invention, it is preferable that this is carried out before the centrifuge processing from the standpoints of filterability and dischargeability of the inkjet ink.

As the surfactant that is further mixed in the polymer particle dispersion liquid, well known surfactants can be used without any particular limitation. For example, the surfactants described below can be can be preferably used. In the present invention, it is preferable that the surfactant is a carboxylate salt-based surfactant from the standpoints of filterability and dischargeability of the inkjet ink.

As long as the carboxylate salt-based surfactant is a surfactant having a carboxy group in a molecule thereof, there is no particular limitation with respect thereto. Examples thereof include various refined aliphatic acid soaps such as beef tallow-based aliphatic acid soap, coconut oil-based aliphatic acid soap, rosin acid soap, stearate, oleate and the like, alkenyl succinic acid salt, N-acyl sarcosine salts such as sodium N-lauroyl sarcosine and the like, and the like.

In the present invention, from the standpoints of filterability and dischargeability of the inkjet ink, it is more preferable that the surfactant is a carboxylate salt-based surfactant having two carboxy groups in a molecule thereof, and it is particularly preferable that the surfactant is an alkenyl succinic acid salt-based surfactant.

The addition amount of the surfactant that is further mixed in the polymer particle dispersion liquid is preferably 5 to 30 mass %, more preferably 5 to 20 mass %, and even more preferably 10 to 20 mass %, with respect to the polymer particles. Due to making the addition amount 5 mass % or greater, filterability and dischargeability of the ink is further improved. Furthermore, due to making the addition amount 30 mass % or less, ink aggregation reactivity becomes even better.

The method of producing an inkjet ink of the present invention includes a process of mixing the polymer particle dispersion liquid, which has been subjected to the centrifuge processing, and the water-insoluble coloring particle dispersion liquid. As a result, the fixability, abrasion resistance, scratch resistance, glossiness and water resistance of a recorded image formed by the inkjet ink can be improved.

There is no particular limitation with respect to the method of mixing the polymer particle dispersion liquid, which has been subjected to the centrifuge processing, and the water-insoluble coloring particle dispersion liquid, and a commonly used mixing method can be used.

### (Water-Insoluble Coloring Particle Dispersion Liquid)

The water-insoluble coloring particle dispersion liquid in the present invention can be configured by including at least one coloring agent and at least one dispersing agent. It is preferable that the coloring agent in the present invention is a coloring agent that is almost insoluble or hardly soluble in water from the standpoint of ink coloring properties. Specific examples thereof include various pigments, dispersive dyes, oil-soluble dyes, dyes that form J aggregates, and the like. Among these, pigments are preferable, and organic pigments are more preferable.

In the present invention, a water-insoluble pigment, in itself, or a pigment that has been subjected to surface treatment with a dispersing agent, in itself, can be made to be the water-insoluble coloring particles.

### —Organic Pigment—

Specific examples of the organic pigment that can be used in the present invention are indicated below.

Examples of the organic pigment for orange or yellow include C.I. Pigment Orange 31, C.I. Pigment Orange 43, C.I. Pigment Yellow 12, C.I. Pigment Yellow 13, C.I. Pigment Yellow 14, C.I. Pigment Yellow 15, C.I. Pigment Yellow 17, C.I. Pigment Yellow 74, C.I. Pigment Yellow 93, C.I. Pigment Yellow 94, C.I. Pigment Yellow 128, C.I. Pigment Yellow 138, C.I. Pigment Yellow 151, C.I. Pigment Yellow 155, C.I. Pigment Yellow 180, C.I. Pigment Yellow 185 and the like.

Examples of the organic pigment for magenta or red include C.I. Pigment Red 2, C.I. Pigment Red 3, C.I. Pigment Red 5, C.I. Pigment Red 6, C.I. Pigment Red 7, C.I. Pigment Red 15, C.I. Pigment Red 16, C.I. Pigment Red 48:1, C.I. Pigment Red 53:1, C.I. Pigment Red 57:1, C.I. Pigment Red 122, C.I. Pigment Red 123, C.I. Pigment Red 139, C.I. Pigment Red 144, C.I. Pigment Red 149, C.I. Pigment Red 166, C.I. Pigment Red 177, C.I. Pigment Red 178, C.I. Pigment Red 222, C.I. Pigment Violet 19 and the like.

Examples of the organic pigment for green or cyan include C.I. Pigment Blue 15, C.I. Pigment Blue 15:2, C.I. Pigment Blue 15:3, C.I. Pigment Blue 15:4, C.I. Pigment Blue 16, C.I. Pigment Blue 60, C.I. Pigment Green 7, a siloxane-crosslinked aluminum phthalocyanine disclosed in U.S. Pat. No. 4,311,775 and the like.

Examples of the organic pigment for black include C.I. Pigment Black 1, C.I. Pigment Black 6, C.I. Pigment Black 7 and the like.

Further, although a smaller average particle diameter of the organic pigment is better from the standpoints of transparency and color reproducibility, a larger average particle diameter is preferable from the standpoint of lightfastness. As an average particle diameter for achieving both of these, 10 to 200 nm is preferable, 10 to 150 nm is more preferable, and 10 to 100 nm is even more preferable. Further, a particle size distribution of the organic pigment is not particularly limited and may be either of one having a wide particle size distribution or one having a particle size distribution of a monodispersion. Furthermore, two or more organic pigments having a particle size distribution of a monodispersion may be mixed and used.

### —Dispersing Agent—

The dispersing agent for the organic pigment that can be used in the present invention may be a polymer dispersing agent or a low-molecular surfactant-type dispersing agent. Further, the polymer dispersing agent may be either one of a water-soluble dispersing agent or a non-water-soluble dispersing agent.

The low-molecular surfactant-type dispersing agent (hereinafter, sometimes referred to as a “low-molecular dispersing agent”) is added for the purpose of stably dispersing the organic pigment in the aqueous medium while maintaining low viscosity of the ink. Further, although the low-molecular dispersing agent is a low-molecular dispersing agent having a molecular weight of 2,000 or less, it is preferable that the molecular weight is from 100 to 2,000, and it is more preferable that the molecular weight is from 200 to 2,000.

In the present invention, the low-molecular dispersing agent has a structure including a hydrophilic group and a hydrophobic group. Further, the hydrophilic group and the hydrophobic group may be each independently contained in a molecule in an amount of one or more, and moreover, plural types of the hydrophilic group and the hydrophilic group may be contained. Furthermore, a linking group for linking the hydrophilic group and the hydrophobic group may be appropriately included.

Examples of the hydrophilic group include anionic groups, cationic groups and nonionic groups. Further, the hydrophilic group may include both of an anionic group and a cationic group to provide a betaine-type configuration.

The anionic group may be any group, as long as it is a group having a negative electrical charge. For example, it is preferable that the anionic group is a phosphoric acid group, a phosphonic acid group, a phosphinic acid group, a sulfuric acid group, a sulfonic acid group, a sulfinic acid group or a carboxy group, it is more preferable that the anionic group is a phosphoric acid group or a carboxy group, and it is even more preferable that the anionic group is a carboxy group.

Further, the cationic group may be any group, as long as it is a group having a positive electrical charge. For example, it is preferable that the cationic group is an organic cationic substituent, it is more preferable that the cationic group is a cationic group containing a nitrogen atom or a phosphorous atom. Moreover, it is even more preferable that the cationic group is a pyridinium cation or an ammonium cation.

Further, examples of the nonionic group include polyethylene oxide, polyglycerol, a portion of saccharide units, and the like.

In the present invention, it is preferable that the hydrophilic group is an anionic group. Among these, it is preferable that the hydrophilic group is a phosphoric acid group, a phosphonic acid group, a phosphinic acid group, a sulfuric acid group, a sulfonic acid group, a sulfinic acid group or a carboxy group, it is more preferable that the hydrophilic group is a phosphoric acid group or a carboxy group, and it is even more preferable that the hydrophilic group is a carboxy group.

Further, in a case where the low-molecular dispersing agent has an anionic hydrophilic group, it is preferable that pKa is 3 or greater in view of causing contact with an acidic processing liquid to promote an aggregation reaction. pKa of the low-molecular dispersing agent in the present invention is a value that is experimentally determined according to a titration curve by titrating, with an acid or alkaline aqueous solution, a liquid in which 1 mmol/L of the low-molecular dispersing agent is dissolved in a tetrahydrofuran-water (3:2=V/V) solution. If pKa of the low-molecular dispersing agent is 3 or greater, when contacted with a processing liquid having pH of about 3, 50% or more of the anionic group will theoretically be in a non-dissociated state. Accordingly, the water solubility of the low-molecular dispersing agent is remarkably lowered, and the aggregation reaction occurs. In other words, aggregation reactivity is improved. From this standpoint as well, it is preferable that the low-molecular dispersing agent has a carboxy group as the anionic group.

The hydrophobic group can have a structure such as that of a hydrocarbon-based structure, a fluorocarbon-based structure, a silicone-based structure or the like. In the present invention, in particular, the hydrocarbon-based structure is preferable. Further, these hydrophobic groups may have either of a straight-chain structure or a branched structure. Moreover, the hydrophobic group may have a one-chain structure or a chain structure with more than one chain, and in the case of a structure with two chains or more, plural types of the hydrophobic group may be contained.

Further, the hydrophobic group is preferably a hydrocarbon group having from 2 to 24 carbon atoms, more preferably a hydrocarbon group having from 4 to 24 carbon atoms, and even more preferably a hydrocarbon group having from 6 to 20 carbon atoms.

As water-soluble dispersing agents among the polymer dispersing agents, hydrophilic polymer compounds can be used, and examples of natural hydrophilic polymer compounds include plant polymers such as gum arabic, tragacanth gum, guar gum, karaya gum, locust bean gum, arabinogalactan, pectin, quince seed starch and the like, seaweed-based polymers such as alginic acid, carrageenan, agar and the like, animal-based polymers such as gelatin, casein, albumin, collagen and the like, microbe-based polymers such as xanthene gum, dextran and the like, and the like.

Examples of modified hydrophilic polymer compounds with a natural material as a raw material include cellulose-based polymers such as methyl cellulose, ethyl cellulose, hydroxyethyl cellulose, hydroxypropyl cellulose, carboxymethyl cellulose and the like, starch-based polymers such as sodium carboxymethyl starch, starch sodium phosphate ester and the like, and seaweed-based polymers such as sodium alginate, propylene glycol alginate ester and the like, and the like.

Further, examples of synthetic water-soluble polymer compounds include vinyl-based polymers such as polyvinyl alcohol, polyvinyl pyrrolidone, polyvinyl methyl ether and the like, acrylic resins such as non-crosslinked polyacrylamide, polyacrylic acid or alkali metal salts thereof, water-soluble styrene acrylic resins and the like, water-soluble styrene maleic acid resins, water-soluble vinylnaphthalene acrylic resins, water-soluble vinylnaphthalene maleic acid resins, polyvinyl pyrrolidone, polyvinyl alcohol, alkali metal salts of β-naphthalene sulfonic acid formalin condensate, polymer compounds having a salt of a cationic functional group such as quaternary ammonium, an amino group or the like on a side chain thereof, natural polymer compounds such as shellac and the like, and the like.

Among these, those which comprise a homopolymer such as acrylic acid, methacrylic acid, styrene acrylic acid or the like, or a copolymer of a monomer having another hydrophilic group, and in which a carboxyl group has been introduced, are particularly preferable as the polymer dispersing agent.

As non-water-soluble dispersing agents among the polymer dispersing agents, polymers having both of a hydrophobic portion and a hydrophilic portion can be used, and examples thereof include styrene-(meth)acrylic acid copolymers, styrene-(meth)acrylic acid-(meth)acrylic acid ester copolymers, (meth)acrylic acid ester-(meth)acrylic acid copolymers, polyethylene glycol (meth)acrylate-(meth)acrylic acid copolymers, vinyl acetate-maleic acid copolymers, styrene-maleic acid copolymers and the like.

A weight-average molecular weight of the dispersing agent is preferably from 3,000 to 100,000, more preferably from 5,000 to 50,000, even more preferably from 5,000 to 40,000, and particularly preferably from 10,000 to 40,000.

A mass ratio for mixing the organic pigment and the dispersing agent (organic pigment:dispersing agent) is preferably in a range of from 1:0.06 to 1:3, more preferably in a range of from 1:0.125 to 1:2, and even more preferably in a range of from 1:0.125 to 1:1.5.

The inkjet ink of the present invention is configured by mixing at least one kind of the polymer particle dispersion liquid and at least one kind of the water-insoluble coloring particle dispersion liquid. The content of the polymer particle dispersion liquid in the inkjet ink of the present invention, as an amount of a solid content of the polymer particles, is preferably from 1 to 20 mass %, more preferably from 2 to 15 mass %, and even more preferably from 4 to 15 mass %, with respect to the inkjet ink.

Further, the content of the water-insoluble coloring particle dispersion liquid, as a content of the organic pigment, is preferably from 1 to 25 mass %, more preferably from 2 to 20 mass %, even more preferably from 5 to 20 mass %, and particularly preferably from 5 to 15 mass %, with respect to the inkjet ink.

Moreover, a mass ratio of the contents of the water-insoluble coloring particles and the polymer particles in the inkjet ink is preferably from 1:0.5 to 1:20, more preferably from 1:1 to 1:10, and even more preferably from 1:2 to 1:5.

### (Water-Soluble Organic Solvent)

The inkjet ink of the present invention may include a water-soluble organic solvent. By including the water-soluble organic solvent, clogging due to drying of the inkjet ink at ink jetting nozzle in an inkjet recording method can be suppressed. Further, moistening of a recording medium by the ink can be promoted.

In the case where the water-soluble organic solvent is included for the purpose of drying prevention, it is preferably a water-soluble organic solvent having a vapor pressure lower than water. Specific examples thereof include polyvalent alcohols represented by ethylene glycol, propylene glycol, diethylene glycol, polyethylene glycol, thiodiglycol, dithiodiglycol, 2-methyl-1,3-propanediol, 1,2,6-hexanetriol, acetylene glycol derivatives, glycerin, trimethylolpropane and the like, lower alkyl ethers of polyvalent alcohols such as ethylene glycol monomethyl (or ethyl)ether, diethylene glycol monomethyl (or ethyl)ether, triethylene glycol monomethyl (or butyl)ether and the like, heterocycles such as 2-pyrrolidone, N-methyl-2-pyrrolidone, 1,3-dimethyl-2-imidazolidinone, N-ethylmorpholine and the like, sulfur-containing compounds such as sulfolane, dimethylsulfoxide, 3-sulfolene and the like, multifunctional compounds such as diacetone alcohol, diethanolamine and the like, and urea derivatives. Among these, polyvalent alcohols such as glycerin, diethylene glycol and the like are preferable. Further, the aforementioned water-soluble organic solvent may be used singly, or two or more kinds thereof may be used in a combination. It is preferable that these water-soluble organic solvents are contained in the ink in an amount of from 10 to 50 mass %.

Further, the water-soluble organic solvent can be preferably used for the purpose of causing the ink to penetrate in a favorable manner into the recording medium (printing sheet). As specific examples, alcohols such as ethanol, isopropanol, butanol, di(tri)ethylene glycol monobutyl ether, 1,2-hexanediol and the like can be preferably used. These water-soluble organic solvents exhibit sufficient effects by being contained in an ink composition in an amount of from 5 to 30 mass %. Further, it is preferable that the water-soluble organic solvent is used within a range of addition amounts at which bleeding of printing and print-through do not occur.

Further, the water-soluble organic solvent can be included for the purpose of adjusting viscosity of the inkjet ink. Specific examples of the water-soluble organic solvent that can be used for adjustment of viscosity include alcohols (e.g., methanol, ethanol, propanol, isopropanol, butanol, isobutanol, sec-butanol, t-butanol, pentanol, hexanol, cyclohexanol, and benzyl alcohol), polyvalent alcohols (e.g., ethylene glycol, diethylene glycol, triethylene glycol, polyethylene glycol, propylene glycol, dipropylene glycol, polypropylene glycol, butylene glycol, hexanediol, pentanediol, glycerin, hexanetriol, and thiodiglycol), glycol derivatives (e.g., ethylene glycol monomethyl ether, ethylene glycol monoethyl ether, ethylene glycol monobutyl ether, diethylene glycol monomethyl ether, diethylene glycol monobutyl ether, propylene glycol monomethyl ether, propylene glycol monobutyl ether, dipropylene glycol monomethyl ether, triethylene glycol monomethyl ether, ethylene glycol diacetate, ethylene glycol monomethyl ether acetate, triethylene glycol monomethyl ether, triethylene glycol monoethyl ether, and ethylene glycol monophenyl ether), amines (e.g., ethanolamine, diethanolamine, triethanolamine, N-methyldiethanolamine, N-ethyldiethanolamine, morpholine, N-ethylmorpholine, ethylenediamine, diethylenetriamine, triethylenetetramine, polyethyleneimine, and tetramethylpropylenediamine) and other polar solvents (e.g., formamide, N,N-dimethylformamide, N,N-dimethylacetamide, dimethylsulfoxide, sulfolane, 2-pyrrolidone, N-methyl-2-pyrrolidone, N-vinyl-2-pyrrolidone, 2-oxazolidone, 1,3-dimethyl-2-imidazolidinone, acetonitrile, and acetone). It should be noted that the water-soluble organic solvent may be used singly, or two or more kinds thereof may be used in a combination.

### (Other Additives)

The inkjet ink of the present invention can further contain other additives in accordance with necessity. Examples of these other additives include well known additives such as a drying preventing agent (moistening agent), a discoloration preventing agent, an emulsion stabilizing agent, a penetration promoting agent, an ultraviolet ray absorbing agent, a preservative, an antifungal agent, a pH adjusting agent, a surface tension adjusting agent, an antifoaming agent, a viscosity adjusting agent, a dispersing agent, a dispersion stabilizing agent, an anticorrosion agent, a chelating agent and the like.

The ultraviolet ray absorbing agent is used, for example, for the purpose of improving storability of an image. As the ultraviolet ray absorbing agent, benzotriazole-based compounds described in JP-A Nos. 58-185677, 61-190537, 2-782, 5-197075 and 9-34057, benzophenone-based compounds described in JP-A Nos. 46-2784 and 5-194483 and U.S. Pat. No. 3,214,463, cinnamic acid-based compounds described in JP-B Nos. 48-30492 and 56-21141 and JP-A No. 10-88106, triazine-based compounds described in JP-A Nos. 4-298503, 8-53427, 8-239368 and 10-182621 and Japanese National Phase Publication No. 8-501291, compounds described in Research Disclosure No. 24239, and compounds that absorb ultraviolet rays to emit fluorescence, represented by stilbene-based and benzoxazole-based compounds, that is, so-called fluorescent brightening agents, can be used.

The discoloration preventing agent is used, for example, for the purpose of improving the storability of an image. As the discoloration preventing agent, various organic-based and metal complex-based discoloration preventing agents can be used. Examples of the organic discoloration preventing agent include hydroquinones, alkoxy phenols, dialkoxy phenols, phenols, anilines, amines, indanes, chromans, alkoxy anilines, heterocycles and the like, and examples of the metal complex include a nickel complex and a zinc complex. More specifically, compounds described in patents cited in items I to J of part VII of Research Disclosure No. 17643, Research Disclosure No. 15162, the left column of page 650 of Research Disclosure No. 18716, page 527 of Research Disclosure No. 36544, page 872 of Research Disclosure No. 307105, and Research Disclosure No. 15162, and compounds included in the general formulae and compound examples of the representative compounds described on pages 127 to 137 of JP-A No. 62-215272 can be used.

Examples of the antifungal agent include sodium dehydroacetate, sodium benzoate, sodium pyridinethion-1-oxide, p-hydroxybenzoate ethyl ester, 1,2-benzoisothiazolin-3-one and salts thereof. It is preferable that these are used in the ink in an amount of 0.02 to 1.00 mass %.

As the pH adjusting agent, a neutralizing agent (organic base or inorganic alkali) can be used. For the purpose of improving storage stability of the inkjet ink, the pH adjusting agent is preferably added so that the pH of the inkjet ink becomes from 6 to 10, and more preferably added so that the pH becomes from 7 to 10.

Examples of the surface tension adjusting agent that is used in the present exemplary embodiment include a nonionic surfactant, a cationic surfactant, an anionic surfactant, a betaine surfactant and the like.

Further, in order to jet droplets in a favorable manner in inkjetting, an addition amount of the surface tension adjusting agent is preferably an addition amount that adjusts the surface tension of the ink to within a range of from 20 to 60 mN/m, more preferably an addition amount that adjusts the surface tension of the ink to within a range of from 20 to 45 mN/m, and even more preferably an addition amount that adjusts the surface tension of the ink to within a range of from 25 to 40 mN/m.

Preferable specific examples of the surfactant include, as those that are hydrocarbon-based, anionic surfactants such as fatty acid salts, alkyl sulfate ester salts, alkylbenzene sulfonate salts, alkylnaphthalene sulfonate salts, dialkyl sulfosuccinate salts, alkylphosphate ester salts, naphthalene sulfonate formalin condensates, polyoxyethylene alkylsulfate ester salts and the like, and nonionic surfactants such as polyoxyethylene alkyl ethers, polyoxyethylene alkylaryl ethers, polyoxyethylene fatty acid esters, sorbitan fatty acid esters, polyoxyethylene sorbitan fatty acid esters, polyoxyethylene alkylamines, glycerin fatty acid esters, oxyethylene oxypropylene block copolymers and the like. Further, SURFYNOLS (produced by Air Products & Chemicals, Inc.), which is an acetylene-based polyoxyethylene oxide surfactant, can also be preferably used. Furthermore, amine oxide-type amphoteric surfactants, such as N,N-dimethyl-N-alkylamine oxides, and the like are also preferable.

In addition, the surfactants described in on pages 37-38 of JP-A No. 59-157636 and in Research Disclosure No. 308119 (1989) can also be used.

Further, by using fluorine-based (alkyl fluoride-based) surfactants and silicone-based surfactants such as described in JP-A Nos. 2003-322926, 2004-325707 and 2004-309806, abrasion resistance can also be improved.

Further, these surface tension adjusting agents can also be used as antifoaming agents, and chelating agents and the like represented by fluorine-based compounds, silicone-based compounds and EDTA can also be used.

The inkjet ink produced by the method of producing an inkjet ink of the invention can be used, not only for monochromatic image formation, but also for full color image formation. In order to form full color images, magenta color-toned ink, cyan color-toned ink and yellow color-toned ink can be used, and further, in order to adjust the color tone, black color-toned ink may also be further used. Furthermore, aside from the yellow, magenta and cyan color-toned inks, red, green, blue and white inks, so-called specific color inks (for example, colorless) in the printing field, and the like can be used.

### <Ink Set>

The ink set of the present invention includes at least one type of the above-described inkjet ink and at least one type of processing liquid that causes the ink to aggregate. It is preferable that the processing liquid is a processing liquid that changes a pH environment of the inkjet ink.

By contacting the inkjet ink and the processing liquid included in the ink set of the present invention, it is possible to change the dispersion stability of the polymer particles in the inkjet ink and cause the polymer particles to rapidly aggregate. Due to the polymer particles aggregating together with the water-insoluble coloring particles in the inkjet ink, a colored image can be formed as coloring aggregates. The colored image may be directly formed on a recording medium, or alternatively, the colored image may be formed on the recording medium by forming the colored image on an intermediate transfer body, and then transferring the formed colored image onto the recording medium.

The pH of the processing liquid used in the present invention is preferably from 1 to 6, more preferably from 2 to 5, and even more preferably from 3 to 5. Further, as a compound that makes the processing liquid acidic, the compounds having a phosphoric acid group, a phosphonic acid group, a phosphinic acid group, a sulfuric acid group, a sulfonic acid group, a sulfinic acid group and/or a carboxy group, or a salt thereof can be used. In the present invention, it is preferable that compound is a compound having a phosphoric acid group or a carboxy group, and it is more preferable that the compound is a compound having a carboxy group.

Examples of the compound having a carboxy group include compounds having a furan, pyrrole, pyrroline, pyrrolidone, pyrone, thiophene, indole, pyridine or quinoline structure and further having a carboxy group as a functional group, and the like. Specific examples thereof include pyrrolidone carboxylic acid, pyrone carboxylic acid, pyrrole carboxylic acid, furan carboxylic acid, pyridine carboxylic acid, coumarinic acid, thiophene carboxylate, nicotinic acid, derivatives of these compounds, salts of these compounds and the like.

It is preferable that the compound that makes the processing liquid acidic in the present invention is pyrrolidone carboxylic acid, pyrone carboxylic acid, furan carboxylic acid, coumarinic acid, a derivative of these compounds, or a salt of these compounds. It should be noted that one of these compounds may be used, or two or more of these compounds may be used in combination.

Further, the processing liquid may contain other additives within a range that does not impair the effects of the present invention. Examples of these other additives include well known additives such as a drying preventing agent (moistening agent), a discoloration preventing agent, an emulsion stabilizing agent, a penetration promoting agent, an ultraviolet ray absorbing agent, a preservative, an antifungal agent, a pH adjusting agent, a surface tension adjusting agent, an antifoaming agent, a viscosity adjusting agent, a dispersing agent, a dispersion stabilizing agent, an anticorrosion agent, a chelating agent and the like, and additives that are specifically exemplified as other additives that can be contained in the inkjet ink described above can be applied.

### EXAMPLES

Hereinafter, the present invention will be specifically explained by way of examples, but the present invention is not limited by these examples. It should be noted that, unless otherwise noted, the terms “parts” and “%” are in accordance with a mass standard.

### Example 1

### Preparation of Ink C-1

### —Preparation of Polymer Particle Dispersion Liquid—

200 g of JONCRYL 537 (manufactured by BASF Japan Ltd.) (pH of 8.9), 9.0 g of sodium oleate (surfactant), and 191 g of ion-exchanged water were mixed to prepare a polymer particle dispersion liquid. Thereafter, a high-speed cooled centrifuge 7750 (manufactured by KUBOTA Corporation) and a high-capacity angle rotor AG-2506 (centrifuge radius of 14.2 cm) were used, 200 mL of the polymer particle dispersion liquid was put into a centrifuge polyvinyl container having a size of 250 mL, and centrifugal separation was executed for one hour at a rotation speed of 13,000 rpm (centrifugal acceleration=26,830×g). After the centrifuge processing, a supernatant of the polymer particle dispersion liquid was filtered with a 32 μm nylon mesh (N-No380T, manufactured by NBA), and a filtrate was recovered to prepare a polymer particle dispersion liquid A-1 that has been subjected to centrifuge processing.

It should be noted that as a result of evaporating a water content of the polymer particle dispersion liquid A-1 at 120° C. for two hours under reduced pressure and measuring a weight of the residue as a solid content, the solid content was 24.1%. Further, pH was 9.1.

### —Preparation of Water-Insoluble Coloring Particle Dispersion Liquid—

### {Polymer Dispersing Agent Solution}

Six parts of styrene, 11 parts of stearyl methacrylate, 4 parts of a styrene macromer AS-6 (manufactured by Toagosei Co., Ltd.), 5 parts of BLEMMER PP-500 (manufactured by NOF Corporation), 5 parts of methacrylic acid, 0.05 parts of 2-mercaptoethanol and 24 parts of methyl ethyl ketone were put into a reaction container to prepare a reaction mixture solution.

Meanwhile, 14 parts of styrene, 24 parts of stearyl methacrylate, 9 parts of a styrene macromer AS-6 (manufactured by Toagosei Co., Ltd.), 9 parts of BLEMMER PP-500 (manufactured by NOF Corporation), 10 parts of methacrylic acid, 0.13 parts of 2-mercaptoethanol, 56 parts of methyl ethyl ketone and 1.2 parts of 2,2′-azobis(2,4-dimethyl valeronitrile) were put into a dropping funnel to prepare a reaction mixture solution.

Under a nitrogen atmosphere, a temperature was raised to 75° C. while the reaction mixture solution in the reaction container was stirred, and the mixture solution in the dropping funnel was gradually dropped therein over a period of one hour. After passage of two hours from the completion of the dropping, a solution in which 1.2 parts of 2,2′-azobis(2,4-dimethyl valeronitrile) was dissolved in 12 parts of methyl ethyl ketone was dropped therein over a period of three hours, and this was further ripened at 75° C. for two hours and at 80° C. for two hours to obtain a polymer dispersing agent solution.

Using a portion of the obtained polymer dispersing agent solution, the polymer dispersing agent was isolated by removing the solvent. The obtained solid content was diluted to 0.1 mass % with tetrahydrofuran, and measurement was carried out with a high-speed GPC (gel permeation chromatography) system HLC-8220GPC with TSKgel SuperHZM-H, TSKgel SuperHZ4000, and TSKgel SuperHZ2000 connected in a three-column straight line, whereby the weight-average molecular weight by polystyrene conversion was 25,000.

5.0 g, by solid content conversion, of the obtained polymer dispersing agent, 10.0 g of a cyan pigment PIGMENT BLUE 15:3 (manufactured by Dainichiseika Color & Chemicals Mfg. Co., Ltd.), 40.0 g of methyl ethyl ketone, 8.0 g of 1 mol/L sodium hydroxide, 82.0 g of ion-exchanged water, and 300 g of 0.1 mm zirconia beads were added to a vessel, and this was dispersed in a ready mill disperser (manufactured by AIMEX Co., Ltd.) at 1,000 rpm for six hours. The obtained dispersion liquid was subjected to vacuum concentration in an evaporator until the methyl ethyl ketone could be sufficiently distilled away, and was concentrated until a pigment concentration became 10%. With respect to the obtained dispersion liquid, a high-speed cooled centrifuge 7750 (manufactured by KUBOTA Corporation) and a high-capacity angle rotor AG-2506 (centrifuge radius of 14.2 cm) were used, 200 mL of the pigment dispersion liquid was put into a centrifuge polyvinyl container having a size of 250 mL, centrifugal separation was executed for 30 minutes at a centrifugal acceleration of 10,000×g, and a supernatant was recovered to prepare a cyan dispersion liquid (water-insoluble coloring particle dispersion liquid).

It should be noted that the pigment particle diameter of the obtained cyan dispersion liquid was 80 nm.

Using the cyan dispersion, an inkjet ink was prepared so that the composition thereof was as indicated in the following Table 1, and after the preparation thereof, bulky particles were removed with a 5 μm filter to prepare an inkjet ink C-1.

TABLE 1

| Material | Mass % |
|---|---|
| Cyan pigment PIGMENT BLUE 15:3 | 4 (solid content) |
| (Manufactured by Dainichiseika Color & | |
| Chemicals Mfg. Co., Ltd.) | |
| Polymer dispersing agent solution | 2 (solid content) |
| Polymer particle dispersion liquid | 8 (solid content) |
| Glycerin | 20 |
| (Manufactured by Wako Pure Chemical | |
| Industries, Ltd.) | |
| Diethylene glycol | 10 |
| (Manufactured by Wako Pure Chemical | |
| Industries, Ltd.) | |
| OLFIN E1010 | 1 |
| (Manufactured by Nissin Chemical | |
| Industry Co., Ltd.) | |
| Ion-exchanged water | 55 |

### Example 2

A polymer particle dispersion liquid A-2 was prepared in the same manner as in Example 1, except that ion-exchanged water of an equivalent mass was added in place of the sodium oleate (surfactant) in the preparation of the polymer particle dispersion liquid of Example 1.

Next, an inkjet ink C-2 was prepared in the same manner as in Example 1, except that the polymer particle dispersion liquid A-2 was used in place of the polymer particle dispersion liquid A-1.

### Example 3

A polymer particle dispersion liquid A-3 was prepared in the same manner as in Example 1, except that the rotation speed of the centrifuge processing was changed to 8,000 rpm in place of the rotation speed of 13,000 rpm in the preparation of the polymer particle dispersion liquid of Example 1.

Next, an inkjet ink C-3 was prepared in the same manner as in Example 1, except that the polymer particle dispersion liquid A-3 was used in place of the polymer particle dispersion liquid A-1.

### Example 4

A polymer particle dispersion liquid A-4 was prepared in the same manner as in Example 1, except that ion-exchanged water of an equivalent mass was added in place of the sodium oleate (surfactant), and that the rotation speed of the centrifuge processing was changed to 8,000 rpm in place of the rotation speed of 13,000 rpm, in the preparation of the polymer particle dispersion liquid of Example 1.

Next, an inkjet ink C-4 was prepared in the same manner as in Example 1, except that the polymer particle dispersion liquid A-4 was used in place of the polymer particle dispersion liquid A-1.

### Comparative Example 1

A polymer particle dispersion liquid A-5 was prepared in the same manner as in Example 1, except that the centrifuge processing and the filtering in the preparation of the polymer particle dispersion liquid of Example 1 were not carried out.

Next, an inkjet ink C-5 was prepared in the same manner as in Example 1, except that the polymer particle dispersion liquid A-5 was used in place of the polymer particle dispersion liquid A-1.

### Comparative Example 2

A polymer particle dispersion liquid A-6 was prepared in the same manner as in Example 1, except that ion-exchanged water of an equivalent mass was added in place of the sodium oleate (surfactant) in the preparation of the polymer particle dispersion liquid of Example 1, and that the centrifuge processing and the filtering in the preparation of the polymer particle dispersion liquid of Example 1 were not carried out.

Next, an inkjet ink C-6 was prepared in the same manner as in Example 1, except that the polymer particle dispersion liquid A-6 was used in place of the polymer particle dispersion liquid A-1.

### Example 5

A polymer particle dispersion liquid A-11 was prepared in the same manner as in Example 1, except that 6.75 g of the sodium oleate was added in place of the 9.0 g of the sodium oleate (surfactant) in the preparation of the polymer particle dispersion liquid of Example 1.

Next, an inkjet ink C-11 was prepared in the same manner as in Example 1, except that the polymer particle dispersion liquid A-11 was used in place of the polymer particle dispersion liquid A-1.

### Example 6

A polymer particle dispersion liquid A-12 was prepared in the same manner as in Example 1, except that 24.2 g (solid component of 28%; 6.75 g by solid content conversion) of an alkenyl succinic acid salt-based surfactant (LATEMUL ASK, manufactured by Kao Corporation) was added in place of the 9.0 g of the sodium oleate (surfactant) in the preparation of the polymer particle dispersion liquid of Example 1.

Next, an inkjet ink C-12 was prepared in the same manner as in Example 1, except that the polymer particle dispersion liquid A-12 was used in place of the polymer particle dispersion liquid A-1.

### Example 7

A polymer particle dispersion liquid A-13 was prepared in the same manner as in Example 1, except that 6.75 g (by solid content conversion) of a sulfonic acid salt-based surfactant (PIONIN A-43S, manufactured by Takemoto Oil & Fat Co., Ltd.) was added in place of the 9.0 g of the sodium oleate (surfactant) in the preparation of the polymer particle dispersion liquid of Example 1.

Next, an inkjet ink C-13 was prepared in the same manner as in Example 1, except that the polymer particle dispersion liquid A-13 was used in place of the polymer particle dispersion liquid A-1.

### Example 8

### Preparation of Polymer Particle Dispersion Liquid

10.7 g of LATEMUL ASK (manufactured by Kao Corporation) (solid content of 28%; equivalent to 3.0 g by solid content conversion), 0.4 g of a 1N sodium hydroxide aqueous solution, and 0.3 g of 2,2′-azobis(2-amidinopropane)dihydrochloride was added to 125 g of water and uniformly dissolved. This was heated to 70° C., and a mixture of 39 g of styrene and 21 g of butyl acrylate was added over a period of two hours under a nitrogen gas flow. Thereafter, this was heated at 70° C. for two hours and at 80° C. for three hours, whereby a latex LX-01 (polymer particle dispersion liquid) having a milky white color and exhibiting excellent dispersibility was obtained.

After this was cooled to room temperature, a high-speed cooled centrifuge 7750 (manufactured by KUBOTA Corporation) and a high-capacity angle rotor AG-2506 (centrifuge radius of 14.2 cm) were used, 200 mL of the latex LX-01 was put into a centrifuge polyvinyl container having a size of 250 mL, and centrifugal separation was executed for one hour at a rotation speed of 13,000 rpm (centrifugal acceleration=26,830×g). After the centrifuge processing, a supernatant of the latex was filtered with a 32 μm nylon mesh (N-No380T, manufactured by NBA), and a filtrate was recovered to prepare a polymer particle dispersion liquid A-21 that has been subjected to centrifuge processing.

The obtained polymer particle dispersion liquid A-21 had pH of 8.3, a solid content concentration of 30 mass %, an average particle diameter of 54 nm (according to a light scattering method), and a weight-average molecular weight (Mw) of 468,000.

### —Preparation of Water-Insoluble Coloring Particle Dispersion Liquid—

An inkjet ink C-21 was prepared in the same manner as in Example 1, except that the polymer particle dispersion liquid A-21 obtained as described above was used in place of the polymer particle dispersion liquid A-1 in Example 1.

### Example 9

A polymer particle dispersion liquid A-22 was prepared in the same manner as in Example 8, except that the centrifuge processing was carried out after further adding and mixing 11 g (3.08 g by solid content conversion) of an alkenyl succinic acid salt-based surfactant (LATEMUL ASK, solid content of 28%, manufactured by Kao Corporation) in the obtained latex LX-01, in Example 8.

Next, an inkjet ink C-22 was prepared in the same manner as in Example 1, except that the polymer particle dispersion liquid A-22 was used in place of the polymer particle dispersion liquid A-1.

### Example 10

A polymer particle dispersion liquid A-23 was prepared in the same manner as in Example 9, except that 22 g (6.16 g by solid content conversion) of the alkenyl succinic acid salt-based surfactant (LATEMUL ASK, solid content of 28%, manufactured by Kao Corporation) was used in place of the 11 g thereof in Example 9.

Next, an inkjet ink C-23 was prepared in the same manner as in Example 1, except that the polymer particle dispersion liquid A-23 was used in place of the polymer particle dispersion liquid A-1.

### Example 11

A polymer particle dispersion liquid A-24 was prepared in the same manner as in Example 9, except that 33 g (9.24 g by solid content conversion) of the alkenyl succinic acid salt-based surfactant (LATEMUL ASK, solid content of 28%, manufactured by Kao Corporation) was used in place of the 11 g thereof in Example 9.

Next, an inkjet ink C-24 was prepared in the same manner as in Example 1, except that the polymer particle dispersion liquid A-24 was used in place of the polymer particle dispersion liquid A-1.

### (Preparation of Processing Liquid)

The composition shown in the following Table 2 was mixed to prepare a processing liquid T-1.

Upon measuring the physical property values of the obtained processing liquid T-1, pH was 3.6, surface tension was 21.1 mPa·s, and viscosity was 2.9 mN/m.

The surface tension was measured according to an ordinary method using a CBVP-Z manufactured by Kyowa Interface Science Co., Ltd., and the viscosity was measured according to an ordinary method using a DV-II+VISCOMETER manufactured by Brookfield Engineering Laboratories., Inc.

TABLE 2

| Material | Parts by Mass |
|---|---|
| 2-pyrrolidone-5-carboxylic acid | 10 |
| (Manufactured by Tokyo Chemical Industry Co., Ltd.) | |
| Lithium hydroxide monohydrate | 2 |
| (Manufactured by Wako Pure Chemical Industries, Ltd.) | |
| Glycerin | 13 |
| (Manufactured by Wako Pure Chemical Industries, Ltd.) | |
| Diethylene glycol | 10 |
| (Manufactured by Wako Pure Chemical Industries, Ltd.) | |
| OLFIN E1010 | 1.5 |
| (Manufactured by Nissin Chemical Industry Co., Ltd.) | |
| sodium 1,4-bis(1H,1H,2H,2H-perfluorohexyl) | 0.1 |
| sulfosuccinate (fluorine-based surfactant) | |
| Ion-exchanged water | 73.4 |

### [Evaluation]

The inkjet inks obtained as described above were subjected to the following evaluation, and the results thereof are shown in Table 3. It should be noted that “surfactant amount” in Table 3 means an addition amount of the surfactant that is added additionally, before the polymer particle dispersion liquid is subjected to the centrifuge processing.

### <Filterability Evaluation>

50 mL of the inkjet ink prepared as described above was filled into a plastic disposable syringe and filtered with a PVDF 5 μl filter (MILLEX-SV, manufactured by Millipore, diameter of 25 mm). A filtered liquid amount was measured and evaluated according to the following evaluation criteria.

### —Evaluation Criteria—

A: 50 mL or more

B: 10 mL or more, and less than 50 mL

C: 5 mL or more, and less than 10 mL

D: less than 5 mL

### <Dischargeability Evaluation>

The inkjet ink prepared as described above was refilled into an ink cartridge of a PX-G930 inkjet printer manufactured by Seiko Epson Corporation, a discharge rate when a nozzle check pattern was discharged was calculated, and evaluation was carried out according to the following evaluation criteria.

### —Evaluation Criteria—

A: 99% or more

B: 95% or more, and less than 99%

C: 90% or more, and less than 95%

D: less than 90%<

### <Aggregability Evaluation>

The processing liquid T-1 was coated at a thickness of 5 μm with a wire bar coater (lot No. 3), on a support of an SR series silicone rubber sheet (manufactured by Tigers Polymer Corporation) having a film thickness of 0.5 mm, and the processing liquid was dried for one minute on a hot plate heated to 70° C. Thereafter, droplets were ejected with an ink droplet ejection amount of 3 to 4 μL at a resolution of 1200×600 dpi using a GEL JET GX5000 printer head manufactured by Ricoh Company, Ltd.

Following the ink droplet ejection, 1.5 seconds later, coloring material adhesion to KAYDRY, manufactured by Crecia, was observed with a roller around which the KAYDRY was wound. Evaluation was carried out three times each, respectively, and aggregation speed was evaluated according to the following evaluation criteria.

### —Evaluation Criteria—

A: no coloring material adhesion can be recognized any of the three times

B: coloring material adhesion can be extremely slightly recognized one or two times

C: coloring material adhesion can be slightly recognized all three times

D: coloring material adhesion can be clearly recognized all three times

TABLE 3

| | | | | Surfactant | | | | |
|---|---|---|---|---|---|---|---|---|
| | | | | Amount | | | | |
| | | Polymer | | (mass % | | | | |
| | | Particle | Centrifugal | with | | Filtered | | |
| | Inkjet | Dispersion | Acceleration | respect to | | Amount | | |
| | Ink | Liquid | (g) | polymer) | Filterability | (mL) | Dischargeability | Aggregability |
| Example 1 | C-1 | A-1 | 26830 | 10 | A | 50 | A | B |
| Example 2 | C-2 | A-2 | 26830 | 10 | B | 10 | B | B |
| Example 3 | C-3 | A-3 | 10160 | 10 | B | 27 | A | B |
| Example 4 | C-4 | A-4 | 10160 | 10 | C | 6 | C | B |
| Comparative | C-5 | A-5 | — | 10 | D | 0 | D | B |
| Example 1 | | | | | | | | |
| Comparative | C-6 | A-6 | — | 10 | D | 0 | D | B |
| Example 2 | | | | | | | | |
| Example 5 | C-11 | A-11 | 26830 | 7.5 | B | 30 | B | A |
| Example 6 | C-12 | A-12 | 26830 | 7.5 | A | 50 | A | B |
| Example 7 | C-13 | A-13 | 26830 | 7.5 | A | 50 | A | C |
| Example 8 | C-21 | A-21 | 26830 | 0 | C | 7 | C | A |
| Example 9 | C-22 | A-22 | 26830 | 5 | B | 45 | B | B |
| Example 10 | C-23 | A-23 | 26830 | 10 | A | 50 | A | B |
| Example 11 | C-24 | A-24 | 26830 | 15 | A | 50 | A | C |

From Table 3, it is understood that the inkjet ink of the present invention is greatly improved in filterability and excellent in production suitability. Further, it is understood that the inkjet ink of the present invention is excellent in dischargeability.

Moreover, it is understood that even further excellent filterability is obtained by further adding the surfactant before the centrifuge processing. It can be regarded that the added surfactant realizes effects, for example, due to improvement in dispersion stability under high shear force at the time of the centrifuge processing.

Hereinafter, exemplary embodiments of the present invention are described, but the present invention is not limited thereto.

<1> A method of producing an inkjet ink, the method comprising at least subjecting a polymer particle dispersion liquid to centrifuge processing, and mixing the polymer particle dispersion liquid that has been subjected to the centrifuge processing and a water-insoluble coloring particle dispersion liquid.
<2> The method of producing an inkjet ink according to <1>, further comprising mixing a surfactant in the polymer particle dispersion liquid.
<3> The method of producing an inkjet ink according to <2>, wherein the surfactant is a carboxylate salt-based surfactant or a sulfonic acid salt-based surfactant.
<4> The method of producing an inkjet ink according to <2>, wherein the surfactant is a carboxylate salt-based surfactant.
<5> The method of producing an inkjet ink according to <4>, wherein the carboxylate salt-based surfactant is a carboxylate salt-based surfactant comprising two carboxy groups within one molecule thereof.
<6> The method of producing an inkjet ink according to <5>, wherein the carboxylate salt-based surfactant comprising two carboxy groups within one molecule thereof is an alkenyl succinic acid salt-based surfactant.
<7> The method of producing an inkjet ink according to <2>, wherein the mixing of the surfactant is carried out before the centrifuge processing.
<8> The method of producing an inkjet ink according to <1>, wherein the centrifuge processing is carried out under conditions of 640 to 64,000×g for from 15 minutes to 3 hours.
<9> The method of producing an inkjet ink according to <1>, wherein after the polymer particle dispersion liquid is subjected to the centrifuge processing, recovery of a supernatant of the polymer particle dispersion liquid is carried out, which includes filtration.
<10> The method of producing an inkjet ink according to <2>, wherein pH of a mixed liquid of the polymer particle dispersion liquid and the surfactant is from 7 to 10.
<11> The method of producing an inkjet ink according to <2>, wherein an amount of the surfactant is from 5 to 30 mass % with respect to the polymer particles.
<12> The method of producing an inkjet ink according to <1>, wherein an amount of the water-insoluble coloring particle dispersion liquid is from 1 to 25 mass % with respect to the inkjet ink.
<13> The method of producing an inkjet ink according to <1>, wherein the polymer particle dispersion liquid contains a styrene-acrylic copolymer.
<14> An inkjet ink produced by the method of producing an inkjet ink according to <1>.
<15> An ink set comprising the inkjet ink according to <14> and a processing liquid that causes the ink to aggregate.

According to the present invention, there can be provided an inkjet ink having excellent ink filterability and dischargeability, and a method of producing the same. Further, according to the present invention, there can be provided an ink set in which an aggregation reaction speed of the ink is improved.

All publications, patent applications, and technical standards mentioned in this specification are herein incorporated by reference to the same extent as if each individual publication, patent application, or technical standard was specifically and individually indicated to be incorporated by reference.

What is claimed is:

1. A method of producing an inkjet ink, the method comprising at least subjecting a polymer particle dispersion liquid to centrifuge processing, and mixing the polymer particle dispersion liquid that has been subjected to the centrifuge processing and a water-insoluble coloring particle dispersion liquid.

2. The method of producing an inkjet ink according to claim 1, further comprising mixing a surfactant in the polymer particle dispersion liquid.

3. The method of producing an inkjet ink according to claim 2, wherein the surfactant is a carboxylate salt-based surfactant or a sulfonic acid salt-based surfactant.

4. The method of producing an inkjet ink according to claim 2, wherein the surfactant is a carboxylate salt-based surfactant.

5. The method of producing an inkjet ink according to claim 4, wherein the carboxylate salt-based surfactant is a carboxylate salt-based surfactant comprising two carboxy groups within one molecule thereof.

6. The method of producing an inkjet ink according to claim 5, wherein the carboxylate salt-based surfactant comprising two carboxy groups within one molecule thereof is an alkenyl succinic acid salt-based surfactant.

7. The method of producing an inkjet ink according to claim 2, wherein the mixing of the surfactant is carried out before the centrifuge processing.

8. The method of producing an inkjet ink according to claim 1, wherein the centrifuge processing is carried out under conditions of 640 to 64,000×g for from 15 minutes to 3 hours.

9. The method of producing an inkjet ink according to claim 1, wherein after the polymer particle dispersion liquid is subjected to the centrifuge processing, recovery of a supernatant of the polymer particle dispersion liquid is carried out, which includes filtration.

10. The method of producing an inkjet ink according to claim 2, wherein pH of a mixed liquid of the polymer particle dispersion liquid and the surfactant is from 7 to 10.

11. The method of producing an inkjet ink according to claim 2, wherein an amount of the surfactant is from 5 to 30 mass % with respect to the polymer particles.

12. The method of producing an inkjet ink according to claim 1, wherein an amount of the water-insoluble coloring particle dispersion liquid is from 1 to 25 mass % with respect to the inkjet ink.

13. The method of producing an inkjet ink according to claim 1, wherein the polymer particle dispersion liquid contains a styrene-acrylic copolymer.

14. An inkjet ink produced by the method of producing an inkjet ink according to claim 1.

15. An ink set comprising the inkjet ink according to claim 14 and a processing liquid that causes the ink to aggregate.
